(19) United States
(12) Patent Application Publication
(10) Pub. No.: US 2011/0206857 A1
(43) Pub. Date: Aug. 25, 2011

(54) ULTRA LOW DIELECTRIC MATERIALS USING HYBRID PRECURSORS CONTAINING SILICON WITH ORGANIC FUNCTIONAL GROUPS BY PLASMA-ENHANCED CHEMICAL VAPOR DEPOSITION

(75) Inventors: Kang Sub Yim, Palo Alto, CA (US); Alexandros T. Demos, Fremont, CA (US)

(73) Assignee: APPLIED MATERIALS, INC., Santa Clara, CA (US)

(21) Appl. No.: 13/028,823

(22) Filed: Feb. 16, 2011

Related U.S. Application Data
(60) Provisional application No. 61/308,224, filed on Feb. 25, 2010.
(60) Provisional application No. 61/376,622, filed on Aug. 24, 2010.

(51) Int. Cl. C08F 2/48; C08F 2/46

(52) U.S. Cl. 427/493; 427/509

(57) ABSTRACT

Methods for depositing a low dielectric constant layer on a substrate are provided. In one embodiment, the method includes introducing one or more organosilicon compounds into a chamber, wherein the one or more organosilicon compounds comprise a silicon atom and a porogen component bonded to the silicon atom, reacting the one or more organosilicon compounds in the presence of RF power to deposit a low dielectric constant layer on a substrate in the chamber, and post-treating the low dielectric constant layer to substantially remove the porogen component from the low dielectric constant layer. Optionally, an inert carrier gas, an oxidizing gas, or both may be introduced into the processing chamber with the one or more organosilicon compounds. The post-treatment process may be an ultraviolet radiation cure of the deposited material. The UV cure process may be used concurrently or serially with a thermal or e-beam curing process. The low dielectric constant layers have good mechanical properties and a desirable dielectric constant.

### CROSS-REFERENCE TO OTHER APPLICATIONS

This application claims benefit of U.S. Provisional Patent Application Ser. No. 61/308,224, filed Feb. 25, 2010, and of U.S. Provisional Patent Application Ser. No. 61/376,622, filed Aug. 24, 2010, each of which is incorporated herein by reference.

### BACKGROUND OF THE INVENTION

1. Field of the Invention

Embodiments of the present invention generally relate to the fabrication of integrated circuits. More particularly, embodiments of the present invention relate to a process for depositing low dielectric constant layers for integrated circuits.

2. Description of the Related Art

Integrated circuit geometries have dramatically decreased in size since such devices were first introduced several decades ago. Since then, integrated circuits have generally followed the two year/half-size rule (often called Moore's Law), which means that the number of devices on a chip doubles every two years. Today's fabrication facilities are routinely producing devices having 90 nm and even 65 nm feature sizes, and tomorrow's facilities soon will be producing devices having even smaller feature sizes.

The continued reduction in device geometries has generated a demand for films having lower dielectric constant (k) values because the capacitive coupling between adjacent metal lines must be reduced to further reduce the size of devices on integrated circuits. In particular, insulators having low dielectric constants, less than about 4.0, are desirable. Examples of insulators having low dielectric constants include spin-on glass, fluorine-doped silicon glass (FSG), carbon-doped oxide, and polytetrafluoroethylene (PTFE), which are all commercially available.

More recently, low dielectric constant organosilicon films having k values less than about 3.0 and even less than about 2.5 have been developed. One method that has been used to develop low dielectric constant organosilicon films has been to deposit the films from a gas mixture comprising an organosilicon compound and a compound comprising thermally labile species or volatile groups and then post-treat the deposited films to remove the thermally labile species or volatile groups, such as organic groups, from the deposited films. The removal of the thermally labile species or volatile groups from the deposited films creates nanometer-sized voids in the films, which lowers the dielectric constant of the films, as air has a dielectric constant of approximately 1.

While low dielectric constant organosilicon films that have desirable low dielectric constants have been developed as described above, some of these low dielectric constant films have exhibited less than desirable mechanical properties, such as poor mechanical strength, which renders the films susceptible to damage during subsequent semiconductor processing steps. Semiconductor processing steps which can damage the low dielectric constant films include plasma-based etching processes that are used to pattern the low dielectric constant films. Ashing processes to remove photoresists or bottom anti-reflective coatings (BARC) from the dielectric films and wet etch processes can also damage the films. Additionally, void (or pore) uniformity both in size uniformity and distribution uniformity throughout the deposited materials has been less than desired.

Thus, there remains a need for a process for making low dielectric constant films that have improved uniformity, improved mechanical properties and resistance to damage from subsequent substrate processing steps.

### SUMMARY OF THE INVENTION

The present invention generally provides methods for depositing a low dielectric constant layer. In one embodiment, the method includes introducing one or more organosilicon compounds into a chamber, wherein the one or more organosilicon compounds comprise a silicon atom and a porogen component bonded to the silicon atom, wherein the one or more organosilicon compounds are selected from the group of 5-(bicycloheptenyl)triethoxysilane, 5-(bicycloheptenyl)methyldiethoxysilane, 5-(bicycloheptenyl)dimethylethoxysilane, 5-(bicycloheptenyl)trimethylsilane, 5-(bicycloheptyl)methyldiethoxysilane, 5-(bicycloheptyl)dimethylethoxysilane, 5-(bicycloheptyl)trimethylsilane, 5-(bicycloheptyl)dimethylchlorosilane, cyclohexylmethyldimethoxysilane, isobutylmethyldimethoxysilane, 1-[2-(trimethoxysilyl)ethyl]cyclohexane-3,4-epoxide, 1,1-dimethyl-1-silacyclopentane, (2-cyclohexen-1-yloxy)trimethyl-silane, (cyclohexyloxy)trimethyl-silane, 2,4-cyclopentadien-1-yltrimethylsilane, 1,1-dimethyl-silacyclohexane, and combinations thereof, reacting the one or more organosilicon compounds in the presence of RF power to deposit a low dielectric constant layer on a substrate in the chamber, and post-treating the low dielectric constant layer to substantially remove the porogen component from the low dielectric constant layer. The silicon atom may also be bonded to one or more oxygen atoms. Optionally, an inert carrier gas, an oxidizing gas, or both may be introduced into the processing chamber with the one or more organosilicon compounds. The post-treatment process may be an ultraviolet radiation cure of the deposited material, and the UV cure process may be used concurrently or serially with a thermal, plasma, or e-beam curing process.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a chart illustrating volume percent to radius size of porous structures in another embodiment of a deposited material of a porogen containing organosilicon compound, cyclohexylmethyldimethoxysilane, as described herein and two separate compounds of a porogen precursor and silicon-containing compound.

FIG. 2 is a chart illustrating volume percent to radius size of porous structures in another embodiment of a deposited material of a porogen containing organosilicon compound, 5-(bicycloheptenyl)trimethylsilane, as described herein and two separate compounds of a porogen precursor and silicon-containing compound.

FIGS. 3A-3D are cross-sectional views showing one embodiment of a dual damascene deposition sequence according to one embodiment described herein.

### DETAILED DESCRIPTION

The present invention provides a method of depositing a low dielectric constant layer. The low dielectric constant layer comprises silicon, oxygen, and carbon, which may be referred to as silicon oxycarbide or carbon doped silicon oxide). The layer also comprises nanometer-sized pores. The low dielectric constant layer has a dielectric constant of about 3.0 or less, preferably about 2.6 or less, such as between about 2.1 and 2.5. The low dielectric constant layer may have an elastic modulus of at least about 4 GPa, such as about 6 GPa or greater. The low dielectric constant layer may be used as an intermetal dielectric layer or as another layer, such as a barrier layer, in a layering structure, for example, a multi-layer dual damascene structure. A method of depositing a low dielectric constant layer according to an embodiment of the invention will be described below.

The process may be described as follows. One or more organosilicon compounds may be introduced into a processing chamber. The one or more organosilicon compounds may comprise a silicon atom bonded and a porogen component bonded to the silicon atom. The silicon atom may optionally be bonded to one or more oxygen atoms. An inert carrier gas, such as a noble gas, for example, argon or helium, may be introduced with the one or more organosilicon compounds. Optionally, an oxidizing gas may be introduced into the processing chamber.

The one or more organosilicon compounds, and optionally, the oxidizing gas, are reacted in the presence of RF power to deposit a low dielectric constant material on a substrate in the chamber. The deposited material may then be post-treated with an ultra-violet radiation curing process to substantially remove the porogen component from the low dielectric constant layer.

The chamber into which the one or more organosilicon compounds, and any other optional gases, are introduced may be a plasma enhanced chemical vapor deposition (PECVD) chamber. The plasma for the deposition process may be generated using constant radio frequency (RF) power, pulsed RF power, high frequency RF power, dual frequency RF power, or combinations thereof. An example of a PECVD chamber that may used is a PRODUCER® chamber, available from Applied Materials, Inc. of Santa Clara, Calif. However, other chambers may be used to deposit the low dielectric constant layer.

The one or more organosilicon compounds (which may also be referred to as grafted porogen precursors) include a silicon containing component and a porogen component bonded to a silicon atom of the silicon containing component. The silicon containing component may include a silicon atom bonded to at least one oxygen atom. Suitable organosilicon compounds include:

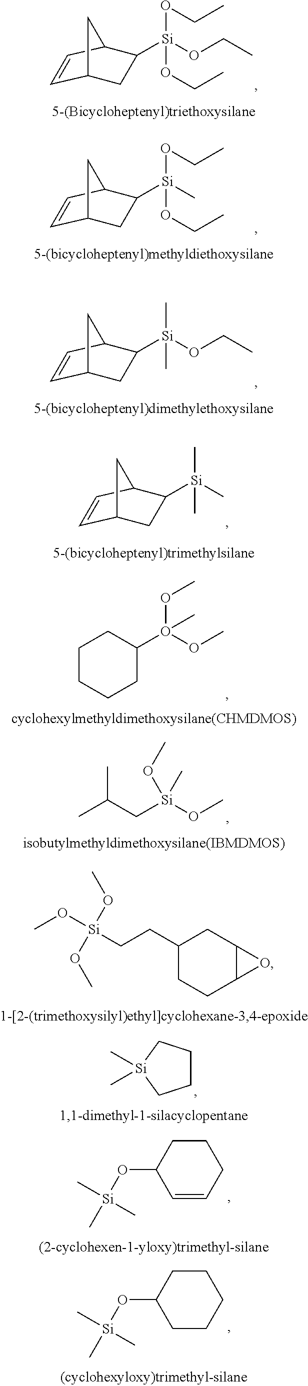

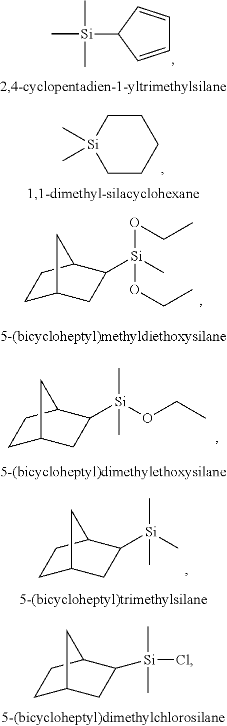

and combinations thereof.

The silicon containing component may comprise any silicon based compound, (and optionally, having at least a silicon-oxygen bond) and may include, for example, compounds selected from the group of trimethylsilane, triethoxysilane, methyldiethoxysilane, dimethylethoxysilane, dimethylmethoxysilane, methyldimethoxysilane, dimethyldisiloxane, tetramethyldisiloxane, 1,3-bis(silanomethylene)disiloxane, bis(1-methyldisiloxanyl)methane, bis(1-methyldisiloxanyl)propane, and combinations thereof. Additional silicon based compounds for the silicon containing component which may be adapted to bond with the porogen component may include compounds selected from the group consisting of dimethyldimethoxysilane (DMDMOS) (which, for example, can be present as dimethylmethoxysilane or methyldimethoxysilane as the silicon containing component after bonding of the porogen component), dimethoxymethylvinylsilane (DMMVS), hexamethyldisiloxane (HMDS), hexamethoxydisiloxane (HMDOS), tetramethylcyclotetrasiloxane (TMCTS), octamethylcyclotetrasiloxane (OMCTS), pentamethylcyclopentasiloxane, hexamethylcymclotrisiloxane, and combinations thereof.

The porogen component may comprise a thermally labile functional group coupled to the silicon atom. The thermally labile functional groups may include bicycloheptenyl, cyclohexyl, isobutyl, cyclohexene epoxy, cyclohexenyl, cyclopentadienyl, derivatives thereof, and combinations thereof. The base porogen compound prior to bonding with the silicon atom may be selected from the group consisting of bicycloheptadiene (norbornadiene), bicycloheptane (norbornane), cyclohexane, isobutane, cyclohexane epoxide, cyclohexene, cyclopentadiene, and combinations thereof. The thermally labile groups devolve from a deposited material when cured and pores, or voids, are formed in the deposited material. The curing process may be an ultraviolet radiation process which may be used serially or concurrently with a thermal or e-beam curing process.

The one or more organosilicon compounds may be mixed with other silicon-containing precursors and porogen precursors for deposition of the low k dielectric layer.

The one or more optional silicon containing precursors may be used with the one or more organosilicon precursors. The one or more silicon containing precursors may be one or more non-porogen component organosilicon compounds, including, for example, dimethyldimethoxysilane (DMDMOS), methyldiethoxysilane (MDEOS), trimethylsilane (TMS), triethoxysilane, dimethylethoxysilane, dimethyldisiloxane, tetramethyldisiloxane, hexamethyldisiloxane (HMDS), 1,3-bis(silanomethylene)disiloxane, bis(1-methyldisiloxanyl)methane, bis(1-methyldisiloxanyl)propane, hexamethoxydisiloxane (HMDOS), dimethoxymethylvinylsilane (DMMVS), and combinations thereof. The one or more silicon containing precursors may include cyclic compounds including tetramethylcyclotetrasiloxane (TMCTS), octamethylcyclotetrasiloxane (OMCTS), pentamethylcyclopentasiloxane, hexamethylcyclotrisiloxane, and combinations thereof.

Further, one or more optional porogen precursors may be used with the one or more organosilicon compounds. Preferred porogens precursors are porogen compounds of the porogen components formed as individual compounds, and include, for example, bicycloheptadiene (norbornadiene), bicycloheptane (norbornane), cyclohexane, isobutane, alpha-terpinene, cyclohexane epoxide, cyclohexene, cyclopentadiene, and combinations thereof, among others.

The oxidizing gases are oxygen containing compounds selected from the group of oxygen (O₂), nitrous oxide (N₂O), ozone (O₃), water (H₂O), carbon dioxide (CO₂), carbon monoxide (CO), and combinations thereof.

The flow rates described above and throughout the instant application are provided with respect to a 300 mm chamber having two isolated processing regions, such as a PRODUCER® chamber, available from Applied Materials, Inc. of Santa Clara, Calif. Thus, the flow rates experienced per each substrate processing region are half of the flow rates into the chamber.

The one or more organosilicon compounds, and optionally, the oxidizing gas and any inert gases, are reacted in the presence of RF power to deposit a low dielectric constant layer on a substrate in the chamber. The one or more organosilicon compounds react to deposit a layer that retains the porogen component (thermally labile groups) therein. Post-treating the layer results in the decomposition and evolution of the porogens (the thermally labile groups) from the layer, resulting in the formation of voids or nanometer-sized pores in the layer.

In application, a substrate is positioned on a substrate support in a processing chamber capable of performing PECVD. A gas mixture having a composition including one or more organosilicon compounds, and optionally the oxidizing gas, is introduced into the chamber through a gas distribution plate of the chamber, such as a showerhead. A radio-frequency (RF) power is applied to an electrode, such as the showerhead, in order to provide plasma processing conditions in the chamber. The gas mixture is reacted in the chamber in the presence of RF power to deposit an initiation layer comprising a silicon oxide layer that adheres strongly to the underlying substrate. The low dielectric constant layer is post-treated to substantially remove the porogen from the low dielectric constant layer.

During the reaction of the one or more organosilicon compounds and the oxidizing gas to deposit the low dielectric constant layer on the substrate in the chamber, the substrate is typically maintained at a temperature between about 0° C. and about 400° C. The chamber pressure may be between about 0.1 Torr and about 50 Torr, such as between about 1 Torr and 15 Torr and the spacing between a substrate support and the chamber showerhead may be between about 100 mils and about 1500 mils, such as between about 200 mils and about 1200 mils.

The one or more organosilicon compounds may be introduced into the chamber at a flow rate from about 10 mg/minute to about 5000 mg/minute, such as at a flow rate from about 100 mg/minute to about 3000 mg/minute. The optional oxidizing gas may be introduced into the chamber at a flow rate from about 0 mg/minute and about 10000 mg/minute, such as at a flow rate from about 0 mg/minute to about 5000 mg/minute. A dilution or carrier gas, such as helium, argon, or nitrogen, may also be introduced into the chamber at a flow rate between about 10 sccm and about 10000 sccm, such as at a flow rate from about 500 mg/minute to about 5000 mg/minute.

The plasma may be generated by applying a power density ranging between about 0.014 W/cm² and about 2.8 W/cm², which is a RF power level of between about 10 W and about 2000 W, such as 0.07 W/cm² and about 1.4 W/cm², which is a RF power level of between about 50 W and about 1000 W for a 300 mm substrate, may be used. The RF power is provided at a frequency between about 0.01 MHz and 300 MHz, such as about 13.56 MHz. The RF power may be provided at a mixed frequency, such as at a high frequency of about 13.56 MHz and a low frequency of about 350 kHz. The RF power may be cycled or pulsed to reduce heating of the substrate and promote greater porosity in the deposited layer. The RF power may also be continuous or discontinuous.

After the low dielectric constant layer is deposited, the layer may be post-treated. In one embodiment, the porogens are removed by application of UV radiation. The UV radiation application may be used in conjunction, concurrently or serially, with additional post-treatments, such as electron beam (e-beam) treatments, plasma-based treatments, thermal annealing treatments, and combinations thereof, among others.

An example of UV post-treatment conditions that may be used include a chamber pressure of between about 1 Torr and about 12 Torr, such as from 1 Torr to 10 Torr, and a substrate support temperature from about 50° C. to about 600° C., such as from about 350° C. to about 500° C. The UV radiation may be provided by any UV source, such as mercury microwave arc lamps, pulsed xenon flash lamps, or high-efficiency UV light emitting diode arrays. The UV radiation may have a wavelength of between about 170 nm and about 400 nm, for example. Helium gas may be supplied at a flow rate of between about 100 sccm and 20,000 sccm. In certain embodiments, gases such as helium, argon, nitrogen gas, hydrogen gas, and oxygen gas, or any combination thereof may be used. The UV power may be between about 25% and about 100% and the processing time period may be between about 0 minutes and about 200 minutes.

Further details of UV chambers and treatment conditions that may be used are described in commonly assigned U.S. patent application Ser. No. 11/124,908, filed on May 9, 2005, which is incorporated by reference herein. The NanoCure™ chamber from Applied Materials, Inc., is an example of a commercially available chamber that may be used for UV post-treatments.

An exemplary thermal annealing post-treatment includes annealing the layer at a substrate temperature between about 200° C. and about 500° C. for about 2 seconds to about 3 hours, preferably about 0.5 to about 2 hours, in a chamber. A non-reactive gas such as helium, hydrogen, nitrogen, or a mixture thereof may be introduced into the chamber at a rate of about 100 to about 10,000 sccm. The chamber pressure is maintained between about 1 mTorr and about 10 Torr. The preferred substrate spacing is between about 300 mils and about 800 mils.

The following examples illustrate embodiments of the invention. The substrates in the examples were 300 mm substrates. The low dielectric constant layers were deposited on the substrates in a PRODUCER® chamber available from Applied Materials, Inc. of Santa Clara, Calif. and UV treated in a NanoCure™ chamber available from Applied Materials, Inc. of Santa Clara, Calif.

The dielectric layers deposited by the above process with the organosilicon compounds described herein have been observed to have dielectric constants from about 2.0 to about 2.5, such as from about 2.2 to about 2.46, a porosity volume from about 20 volume % to about 30 volume %, an elastic modulus of about 6.5 GPa, and an average pore radius from about 6 Å (0.6 nm) to about 17 Å (1.7 nm), such as from about 6 Å (0.6 nm) to about 11 Å (1.1 nm), for example between about 7 Å and about 9 Å after annealing or post-treating.

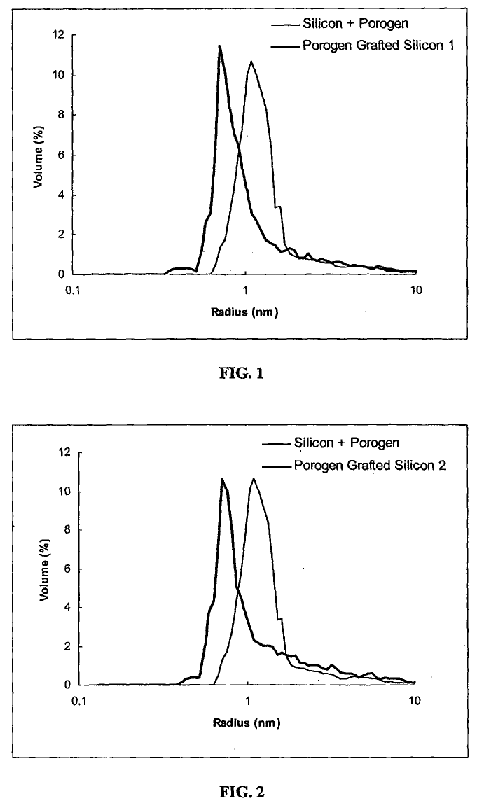

### Example 1 and FIG. 1

A low dielectric constant layer was deposited on a substrate at about 7 Torr and a temperature of about 300° C. The spacing was about 800 mils, and the RF power was provided at about 400 W at about 13.56 MHz. The following processing gases and flow rates were used: cyclohexylmethyldimethoxysilane (CHMDMOS) at about 1000 mgm, oxygen gas at about 0 mgm, and helium at about 3000 sccm. The layer was the post-treated with a UV treatment as described above.

After the post-treatment, the layer was observed to have a dielectric constant of about 2.35, a deposition rate of about 2500 Å/min, a tensile stress of about 55 MPa, an elastic modulus of about 4.5 GPa, about 28% porosity with an average pore radius of about 7.1 Å (0.71 nm), and a measure FTIR ratio of Si—CH₃ bonds to SiO bonds of about 2.7%.

FIG. 1 illustrates a comparison of porosity (porous volume) and average pore structure radius for the above deposited cyclohexylmethyldimethoxysilane (CHMDMOS) organosilicon compound (thick solid line) versus the silicon component (methyldimethoxysilane) and the porogen (bicycloheptadiene (BHCD)) as separate compounds (thin solid line). As shown from FIG. 1, the organosilicon compound deposited layer exhibits greater porosity (greater area under the peak) with a more uniform porous structure size (narrower peak structure than the layer deposited with the silicon component and the porogen as separate compounds). Porosity volume % and pore radius were measured using known techniques.

### Example 2 and FIG. 2

A low dielectric constant layer was deposited on a substrate at about 7 Torr and a temperature of about 300° C. The spacing was about 800 mils, and the RF power was provided at about 400 W at 13.56 MHz. The following processing gases and flow rates were used: 5-(bicycloheptenyl)trimethylsilane at about 1000 mgm, oxygen gas at about 0 mgm, and helium at about 3000 sccm. The layer was the post-treated with a UV treatment as described above.

After the post-treatment, the layer was observed to have a dielectric constant of about 2.43, a deposition rate of about 2000 Å/min, a tensile stress of about 60 MPa, an elastic modulus of about 6.5 GPa, about 23% porosity with an average pore radius of about 7.0 Å (0.7 nm), and a measure FTIR ratio of Si—CH₃ bonds to SiO bonds of about 3.2%.

FIG. 2 illustrates a comparison of porosity (porous volume) and average pore structure radius for the above deposited 5-(bicycloheptenyl)trimethylsilane organosilicon compound (thick solid line) versus the silicon component (methyldimethoxysilane) and the porogen (bicycloheptadiene, also known as norbornadiene) as separate compounds (thin solid line). As shown from FIG. 2, the organosilicon compound deposited layer exhibits greater porosity with a more uniform porous structure size than the layer deposited with the silicon component and the porogen as separate compounds.

It has been observed that depositing dielectric material using a porogen bonded to (grafted) a silicon atom produced more controlled pore structures in deposited silicon oxycarbide materials. FIGS. 1-2 illustrate this controlled pore structure by porogen volume % versus pore radius charts having narrower pore radius variations and in some cases increased porosity volumes as compared to processes with two separate precursors. The improved pore structures have exhibited better resistance to layer damaging processes, such as oxygen ashing to remove resist material from layer patterning processes.

The (porous) low k dielectric layer deposited by the method described herein may be used as an interlayer dielectric material as follows. Alternatively, the (porous) low k dielectric layer deposited by the method described herein may be used as another interlayer dielectric layer, such as an etch stop or barrier layer.

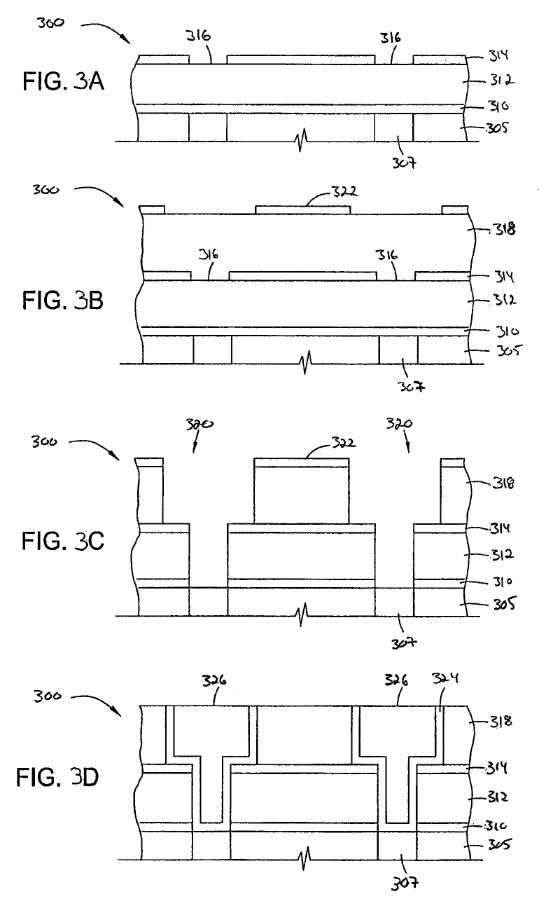

As shown in FIG. 3A, a damascene structure that is formed using a substrate 300 having metal features 307 formed in a substrate surface material 305 therein is provided to a processing chamber. A first barrier layer 310, such as a silicon carbide barrier layer, is generally deposited on the substrate surface to eliminate inter-level diffusion between the substrate and subsequently deposited material. Barrier layer materials may have dielectric constants of up to about 9 and preferably between about 2.5 and less than about 4. Silicon carbide barrier layers may have dielectric constants of about 5 or less, preferably less than about 4. The silicon carbide material of the first barrier layer 310 may be doped with nitrogen and/or oxygen. The barrier layers may be treated with UV treatments, thermal treatments, plasma treatments, e-beam treatments, or combinations thereof.

Optionally, the barrier layers described herein may be deposited from one of the one or more organosilicon compounds described herein. For example, it has been observed that a dielectric layer deposited form isobutylmethyldimethoxysilane has a lower porosity volume and improved barrier properties to other organosilicon compounds described herein. The isobutylmethyldimethoxysilane organosilicon compound may be deposited with an inert gas, an oxidizing gas, or both. An oxygen gas-free deposition process is believed to have better barrier properties and a higher dielectric constant value than a deposition process including an oxidizing gas.

While not shown, a capping layer of nitrogen free silicon carbide or silicon oxide may be deposited on the first barrier layer 310. The nitrogen free silicon carbide or silicon oxide capping layer may be deposited in-situ by adjusting the composition of the processing gas. For example, a capping layer of nitrogen free silicon carbide may be deposited in-situ on the first silicon carbide barrier layer 310 by minimizing or eliminating the nitrogen source gas. Alternatively, and not shown, an initiation layer may be deposited on the first silicon carbide barrier layer 310. Initiation layers are more fully described in U.S. Pat. No. 7,030,041, entitled ADHESION IMPROVEMENT FOR LOW K DIELECTRICS, which is incorporated herein by reference to the extent not inconsistent with the claimed aspects and disclosure herein.

The first dielectric layer 312 is deposited on the silicon carbide barrier layer 310 to a thickness of about 1,000 to about 15,000 Å, depending on the size of the structure to be fabricated, by the method described herein for forming a (porous) low k dielectric layer using the one or more organosilicon compounds described herein. The first dielectric layer 312 may then be post-treated with an ultraviolet process as described herein, which may used in combination with a plasma process, a thermal process, or an e-beam process. Optionally, a silicon oxide cap layer (not shown) may be deposited in-situ on the first dielectric layer 312 by increasing the oxygen concentration in the silicon oxycarbide deposition process described herein to remove carbon from the deposited material. The first dielectric layer may also comprise other low k dielectric material such as a low polymer material including paralyne or a low k spin-on glass such as un-doped silicon glass (USG) or fluorine-doped silicon glass (FSG).

An optional low-k etch stop (or second barrier layer) 314, for example, a silicon carbide layer, which may be doped with nitrogen or oxygen, is then deposited on the first dielectric layer 312. The low-k etch stop 314 may be deposited on the first dielectric layer 312 to a thickness of about 50 Å to about 1,000 Å. The low-k etch stop 314 may be post-treated as described herein for the silicon carbide materials or silicon oxycarbide materials. The low-k etch stop 314 is then pattern etched to define the openings of the contacts/vias 316 and to expose the first dielectric layer 312 in the areas where the contacts/vias 316 are to be formed. In one embodiment, the low k etch stop 314 is pattern etched using conventional photolithography and etch processes using fluorine, carbon, and oxygen ions. While not shown, a nitrogen-free silicon carbide or silicon oxide cap layer between about 100 Å to about 500 Å may optionally be deposited on the low k etch stop 314 prior to depositing further materials.

Referring to FIG. 3B, a second dielectric layer 318 of an organosilicon compound as described herein is then deposited over the optional patterned etch stop 314 and the first dielectric layer 312 after the resist material has been removed. The second dielectric layer 318 may comprise silicon oxycarbide by the method described herein for forming a porous low k dielectric layer, is deposited to a thickness of about 5,000 to about 15,000 Å. The second dielectric layer 318 may then be post-treated with an ultraviolet process as described herein, which may used in combination with a plasma process, a thermal process, or an e-beam process, and/or have a silicon oxide cap material disposed thereon by the process described herein. The same or different organosilicon compound may be used for depositing the second dielectric layer 318 as the first dielectric layer 312.

A resist material 322 is then deposited on the second dielectric layer 318 (or cap layer) and patterned using conventional photolithography processes to define the interconnect lines 320 as shown in FIG. 3B. Optionally an ARC layer and an etch mask layer, such as a hardmask layer (not shown) may be positioned between the resist material 322 and the second dielectric layer 318 to facilitate transferring patterns and features to the substrate 300. The resist material 322 comprises a material conventionally known in the art, preferably a high activation energy resist material, such as UV-5, commercially available from Shipley Company Inc., of Marlborough, Mass. The interconnects and contacts/vias are then etched using reactive ion etching or other anisotropic etching techniques to define the metallization structure (i.e., the interconnect and contact/via) as shown in FIG. 3C. Any resist material or other material used to pattern the etch stop 314 or the second dielectric layer 318 is removed using an oxygen strip or other suitable process.

The metallization structure is then formed with a conductive material such as aluminum, copper, tungsten or combinations thereof. Presently, the trend is to use copper to form the smaller features due to the low resistivity of copper (1.7 mΩ-cm compared to 3.1 mΩ-cm for aluminum). In one embodiment, a suitable metal barrier layer 324, such as tantalum nitride, is first deposited conformally in the metallization pattern to prevent copper migration into the surrounding silicon and/or dielectric material. Thereafter, copper is deposited using techniques such as chemical vapor deposition, physical vapor deposition, electroplating, or combinations thereof to form the conductive structure. Once the structure has been filled with copper or other conductive metal, the surface is planarized using chemical mechanical polishing and exposing the surface of the conductive metal feature 326, as shown in FIG. 3D.

The one or more organosilicon compounds may be used in other deposition schemes, such as a gap fill process. An example of a gap fill process is disclosed in U.S. Pat. No. 6,054,379, issued on Apr. 25, 2000, and entitled “Method Of Depositing A Low K Dielectric With Organo Silane”, which application is incorporated by reference herein to the extent not inconsistent with the claimed aspects and description herein.

While the foregoing is directed to embodiments of the present invention, other and further embodiments of the invention may be devised without departing from the basic scope thereof, and the scope thereof is determined by the claims that follow.

What is claimed is:

1. A method of depositing a low dielectric constant layer, comprising:
introducing one or more organosilicon compounds into a chamber, wherein the one or more organosilicon compounds comprise a silicon atom and a porogen component bonded to the silicon atom, wherein the one or more organosilicon compounds are selected from the group consisting of 5-(bicycloheptenyl)triethoxysilane, 5-(bicycloheptenyl)methyldiethoxysilane, 5-(bicycloheptenyl)dimethylethoxysilane, 5-(bicycloheptenyl)trimethylsilane, 5-(bicycloheptyl)methyldiethoxysilane, 5-(bicycloheptyl)dimethylethoxysilane, 5-(bicycloheptyl)trimethylsilane, 5-(bicycloheptyl)dimethylchlorosilane, cyclohexylmethyldimethoxysilane, isobutylmethyldimethoxysilane, 1-[2-(trimethoxysilyl)ethyl]cyclohexane-3,4-epoxide, 1,1-dimethyl-1-silacyclopentane, (2-cyclohexen-1-yloxy)trimethyl-silane, (cyclohexyloxy)trimethyl-silane, 2,4-cyclopentadien-1-yltrimethylsilane, 1,1-dimethyl-silacyclohexane, and combinations thereof;
reacting the one or more organosilicon compounds in the presence of RF power to deposit a low dielectric constant layer on a substrate in the chamber; and
post-treating the low dielectric constant layer to substantially remove the porogen component from the low dielectric constant layer, wherein the low dielectric constant layer has a porosity volume from about 20 volume % to about 30 volume % and average pore radius from about 6 Å to about 11 Å.

2. The method of claim 1, wherein the post-treating comprises a UV curing treatment.

3. The method of claim 1, wherein the low dielectric constant layer comprises a dielectric constant of about 2.0 to about 2.5.

4. The method of claim 1, further comprising introducing an oxidizing gas into the chamber and reacting the one or more organosilicon compounds and the oxidizing gas in the presence of RF power to deposit a low dielectric constant layer on a substrate in the chamber.

5. The method of claim 4, wherein the oxidizing gas is selected from the group consisting of oxygen (O₂), nitrous oxide (N₂O), ozone (O₃), water (H₂O), carbon dioxide (CO₂), carbon monoxide (CO), and combinations thereof.

6. The method of claim 1, further comprising introducing one or more compounds selected from the group of a silicon containing precursor, a porogen precursor, and combinations thereof.

7. The method of claim 6, wherein the silicon containing precursor comprises one or more porogen-free silicon compounds selected from the group consisting of dimethyldimethoxysilane, methyldiethoxysilane, trimethylsilane, triethoxysilane, dimethylethoxysilane, dimethyldisiloxane, tetramethyldisiloxane, hexamethyldisiloxane, 1,3-bis(silanomethylene)disiloxane, bis(1-methyldisiloxanyl)methane, bis(1-methyldisiloxanyl)propane, hexamethoxydisiloxane, dimethoxymethylvinylsilane, and combinations thereof.

8. The method of claim 6, wherein the silicon containing precursor comprises one or more porogen-free cyclic silicon containing precursors selected from the group consisting of tetramethylcyclotetrasiloxane (TMCTS), octamethylcyclotetrasiloxane (OMCTS), pentamethylcyclopentasiloxane, hexamethylcyclotrisiloxane, and combinations thereof.

9. The method of claim 6, wherein the porogen precursor comprises a porogen compound selected from the group consisting of norbornane, norbornadiene, cyclohexane, isobutane, alpha-terpinene, cyclohexane epoxide, cyclohexene, cyclopentadiene, and combinations thereof.

10. The method of claim 1, wherein the silicon atom is bonded to at least one oxygen atom.

11. The method of claim 4, wherein the low dielectric constant layer comprises silicon oxycarbide and has a dielectric constant of about 2.0 to about 2.5.

12. The method of claim 1, wherein the average pore radius is between about 7 Å and about 9 Å.

13. A method of depositing a low dielectric constant layer, comprising:
introducing one or more organosilicon compounds into a chamber, wherein the one or more organosilicon compounds comprise a silicon atom and a porogen component bonded to the silicon atom, wherein the one or more organosilicon compounds are selected from the group consisting of 5-(bicycloheptenyl)methyldiethoxysilane, 5-(bicycloheptenyl)dimethylethoxysilane, 5-(bicycloheptenyl)trimethylsilane, 5-(bicycloheptyl)methyldiethoxysilane, 5-(bicycloheptyl)dimethylethoxysilane, 5-(bicycloheptyl)trimethylsilane, 5-(bicycloheptyl)dimethylchlorosilane, isobutylmethyldimethoxysilane, 1-[2-(trimethoxysilyl)ethyl]cyclohexane-3,4-epoxide, 1,1-dimethyl-1-silacyclopentane, (2-cyclohexen-1-yloxy)trimethyl-silane, (cyclohexyloxy)trimethyl-silane, 2,4-cyclopentadien-1-yltrimethylsilane, 1,1-dimethyl-silacyclohexane, and combinations thereof;
reacting the one or more organosilicon compounds in the presence of RF power to deposit a low dielectric constant layer on a substrate in the chamber; and
post-treating the low dielectric constant layer to substantially remove the porogen component from the low dielectric constant layer.

14. The method of claim 13, wherein the low dielectric constant layer has a porosity volume from about 20 volume % to about 30 volume % and average pore radius from about 6 Å to about 11 Å after post-treating.

15. The method of claim 14, wherein the average pore radius is between about 7 Å and about 9 Å.
